(19) United States
(12) Patent Application Publication
(10) Pub. No.: US 2023/0241774 A1
(43) Pub. Date: Aug. 3, 2023

(54) SYSTEM AND METHOD FOR REPROGRAMMING TRAJECTORY OF ROBOTIC ARM BASED ON HUMAN INTERACTION

(71) Applicant: Addverb Technologies Limited, Noida (IN)

(72) Inventors: Rajesh KUMAR, New Delhi (IN); Hardeep SINGH, New Delhi (IN)

(73) Assignee: Addverb Technologies Limited, Noida (IN)

(21) Appl. No.: 18/101,825

(22) Filed: Jan. 26, 2023

(30) Foreign Application Priority Data
Feb. 3, 2022 (IN) 202211005801

(51) Int. Cl. B25J 9/16

(52) U.S. Cl. CPC B25J 9/1666; B25J 9/1676; B25J 9/1633

(57) ABSTRACT

A system and method for reprogramming a trajectory of a robotic arm based on a human interaction. The method comprises configuring a motor arrangement to operate the robotic arm to cause movement of an end-effector thereof along a first trajectory predefined therefor. The method further comprises detecting the human interaction related to the end-effector, while the end-effector is moving along the first trajectory. The method further comprises determining instantaneous positional coordinates to which the end-effector is moved in response to the human interaction, deviating from the first trajectory. The method further comprises recording the determined instantaneous positional coordinates. The method further comprises configuring the motor arrangement to operate the robotic arm with movement of the end-effector thereof along a second trajectory based on the recorded instantaneous positional coordinates.

### FIELD OF THE PRESENT DISCLOSURE

The present disclosure generally relates to robotic devices, such as cobots including robotic arms, implemented to work in an industrial environment and the like, and particularly to a system and method for reprogramming a trajectory of the robotic arm based on a human interaction with respect thereto.

### BACKGROUND

Cobot, such as robotic arm, are used in many industrial applications, including manufacturing, object/surface processing and the like. Existing practice for programming the robotic arm involves teaching the robotic arm a sequence of points. Such points define the path, which the robotic arm shall follow during the processing of the object. These points comprise three-dimensional position and three-dimensional orientation information. During the programming, the robotic arm is taught how to perform the task by being guided through the various points along the desired operating path. For such programming operation, if a 3D CAD model of the object exists, a human operator with computer knowledge may teach the points in a robot simulation system. These points are stored as instructions into a memory in a control unit of the robotic arm; and during operation of the robotic arm, the program instructions are executed, thereby making the robotic arm operate as desired.

Now if during operation, the human operator may wish to change the course of the robotic arm on-the-go (i.e., on-the-fly), it is typically not possible with existing technologies. Such human-cobot collaboration is useful where the human feels that the cobot's trajectory is erroneous and wishes to correct the same. The available methods require reprogramming of the cobot in order to ensure that the trajectory is updated. However, such reprogramming may be time consuming, results in cobot's downtime, and is error-prone and thus in almost all cases requires several iterations before such reprogramming may be acceptable. In general, if the cobot and the user have to share a common workspace, the two should be interactable to one another; not only limited to ensuring safety of the two, but the human operator should also be able to manipulate the requisite behaviour/planning of the cobot on-the-go, and may not need to go through the entire process of reprogramming the cobot.

Human cobot collaboration is an exciting field. Numerous researchers have been focusing on the implementation of the human aware algorithms to ensure safety at the workspace. The safety modules, involving stopping the cobot on human intervention are popular. Similarly, correction of the cobot's goal pose based on the human visual feedback by interacting with the cobot is popular. Estimation of the load on the cobot's end-effector and subsequent dynamic estimation are also developed by other researchers. However, dynamic change of trajectory of the cobot in order to avoid obstacles is another important requirement of a successful implementation of the human cobot interaction.

Therefore, in light of the foregoing discussion, there exists a need to overcome problems associated with conventional techniques and provide systems and/or methods for reprogramming a trajectory of a robotic arm based on a human interaction, so as to enable reprogramming of operation of the robotic arm on-the-go.

### SUMMARY

In an aspect of the present disclosure, a method for reprogramming a trajectory of a robotic arm based on a human interaction, in which the robotic arm comprising an end-effector adapted to support a load and adapted to be movable by a motor arrangement. The method comprises configuring the motor arrangement to operate the robotic arm to cause movement of the end-effector thereof along a first trajectory predefined therefor, in between a first position and a second position. The method further comprises detecting the human interaction related to the end-effector, while the end-effector is moving along the first trajectory. The method further comprises determining instantaneous positional coordinates to which the end-effector is moved in response to the human interaction, deviating from the first trajectory. The method further comprises recording the determined instantaneous positional coordinates. The method further comprises configuring the motor arrangement to operate the robotic arm with movement of the end-effector thereof along a second trajectory based on the recorded instantaneous positional coordinates, in between the first position and the second position.

In one or more embodiments, the method further comprises configuring the motor arrangement to generate an opposing force to the human interaction, to resist movement of the end-effector with corresponding one or more instantaneous positional coordinates being beyond a predefined bounded operational coordinate space.

In one or more embodiments, the instantaneous positional coordinates are determined in response to each of at least two human interactions causing the end-effector to deviate from the first trajectory, with the corresponding determined instantaneous positional coordinates resultant of each of the at least two human interactions being within a predefined distance from each other.

In one or more embodiments, the determined instantaneous positional coordinates are recorded in case of detection of at least two human interactions causing the end-effector to deviate from the first trajectory predefined therefor.

In one or more embodiments, the method further comprises detecting the human interaction related to the load supported by the end-effector of the robotic arm.

In another aspect of the present disclosure, a system for reprogramming a trajectory of a robotic arm based on a human interaction is provided. Herein, the robotic arm comprises an end-effector adapted to support a load and adapted to be movable by a motor arrangement. The system comprises a first sensing arrangement configured to detect the human interaction related to the end-effector. The system also comprises a second sensing arrangement configured to determine an instantaneous positional coordinate of the end-effector. The system further comprises a memory and a controller in signal communication with the motor arrangement, the first sensing arrangement, the second sensing arrangement and the memory. The controller is configured to configure the motor arrangement to operate the robotic arm to cause movement of the end-effector thereof along a first trajectory predefined therefor, in between a first position and a second position. The controller is further configured to detect, via the first sensing arrangement, the human interaction related to the end-effector, while the end-effector is moving along the first trajectory. The controller is further configured to determine, via the second sensing arrangement, instantaneous positional coordinates to which the end-effector is moved in response to the human interaction, deviating from the first trajectory. The controller is further configured to record, in the memory, the determined instantaneous positional coordinates. The controller is further configured to configure the motor arrangement to operate the robotic arm with movement of the end-effector thereof along a second trajectory based on the recorded instantaneous positional coordinates, in between the first position and the second position.

In one or more embodiments, the controller is further configured to configure the motor arrangement to generate an opposing force to the human interaction, to resist movement of the end-effector with corresponding one or more instantaneous positional coordinates being beyond a predefined bounded operational coordinate space.

In one or more embodiments, the controller is configured to determine, via the second sensing arrangement, the instantaneous positional coordinates in response to each of at least two human interactions causing the end-effector to deviate from the first trajectory, with the corresponding determined instantaneous positional coordinates resultant of each of the at least two human interactions being within a predefined distance from each other.

In one or more embodiments, the controller is configured to record, in the memory, the determined instantaneous positional coordinates in case of detection, via the first sensing arrangement, of at least two human interactions causing the end-effector to deviate from the first trajectory predefined therefor.

In one or more embodiments, the controller is further configured to detect, via the first sensing arrangement, the human interaction related to the load supported by the end-effector of the robotic arm.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present disclosure, reference is now made to the following descriptions taken in connection with the accompanying drawings in which:

FIG. 1 illustrates a schematic of an exemplary computing system that may reside on and may be executed by a computer, and which may be connected to a network, in accordance with one or more embodiments of the present disclosure;

FIG. 2 illustrates a schematic of an exemplary controller, in accordance with one or more embodiments of the present disclosure;

FIG. 3 illustrates a flowchart listing steps involved in a method for reprogramming a trajectory of a robotic arm based on a human interaction, in accordance with one or more embodiments of the present disclosure;

FIG. 4 illustrates a schematic of a system for reprogramming a trajectory of a robotic arm based on a human interaction, in accordance with one or more embodiments of the present disclosure;

FIGS. 5A-5B illustrate depictions representing the human interaction on the robotic arm, in accordance with one or more embodiments of the present disclosure; and

FIG. 6 illustrates a representation of reprogramming of the trajectory of the robotic arm based on the human interaction, in accordance with one or more embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to these specific details.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fibre cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the used language for training may be one of Python, Tensorflow™, Bazel, C, C++. Further, decoder in user device (as will be discussed) may use C, C++ or any processor specific ISA. Furthermore, assembly code inside C/C++ may be utilized for specific operation. Also, ASR (automatic speech recognition) and G2P decoder along with entire user system can be run in embedded Linux (any distribution), Android, iOS, Windows, or the like, without any limitations. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general-purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

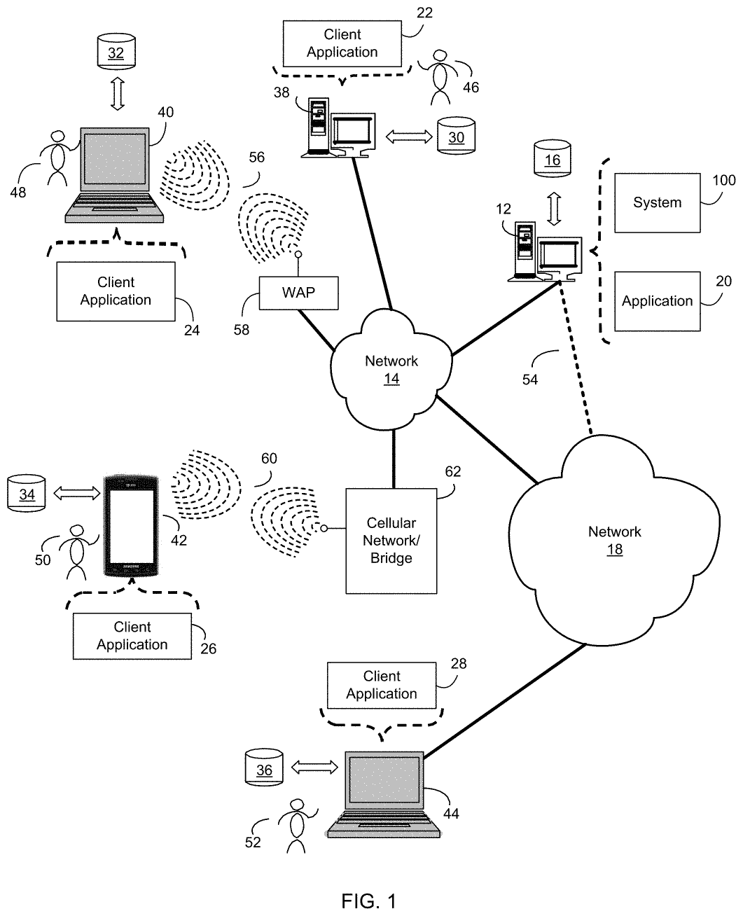

Referring now to the example implementation of FIG. 1, there is shown a computing system 100 that may reside on and may be executed by a computer (e.g., computer 12), which may be connected to a network (e.g., network 14) (e.g., the internet or a local area network). Examples of computer 12 may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, a portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, the instruction sets and subroutines of computing system 100, which may be stored on storage device, such as storage device 16, coupled to computer 12, may be executed by one or more processors (not shown) and one or more memory architectures included within computer 12. In some implementations, storage device 16 may include but is not limited to: a hard disk drive; a flash drive, a tape drive; an optical drive; a RAID array (or other array); a random-access memory (RAM); and a read-only memory (ROM). In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, computing system 100 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute application 20 for reprogramming a trajectory of a robotic arm based on a human interaction. In some implementations, computing system 100 and/or application 20 may be accessed via one or more of client applications 22, 24, 26, 28. In some implementations, computing system 100 may be a standalone application, or may be an applet/application/script/extension that may interact with and/or be executed within application 20, a component of application 20, and/or one or more of client applications 22, 24, 26, 28. In some implementations, application 20 may be a standalone application, or may be an applet/application/script/extension that may interact with and/or be executed within computing system 100, a component of computing system 100, and/or one or more of client applications 22, 24, 26, 28. In some implementations, one or more of client applications 22, 24, 26, 28 may be a standalone application, or may be an applet/application/script/extension that may interact with and/or be executed within and/or be a component of computing system 100 and/or application 20. Examples of client applications 22, 24, 26, 28 may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to user devices 38, 40, 42, 44, may be executed by one or more processors and one or more memory architectures incorporated into user devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of user devices 38, 40, 42, 44 (and/or computer 12) may include, but are not limited to, a personal computer (e.g., user device 38), a laptop computer (e.g., user device 40), a smart/data-enabled, cellular phone (e.g., user device 42), a notebook computer (e.g., user device 44), a tablet (not shown), a server (not shown), a television (not shown), a smart television (not shown), a media (e.g., video, photo, etc.) capturing device (not shown), and a dedicated network device (not shown). User devices 38, 40, 42, 44 may each execute an operating system, examples of which may include but are not limited to, Android®, Apple® iOS®, Mac® OS X®; Red Hat® Linux®, or a custom operating system.

In some implementations, one or more of client applications 22, 24, 26, 28 may be configured to effectuate some or all of the functionality of computing system 100 (and vice versa). Accordingly, in some implementations, computing system 100 may be a purely server-side application, a purely client-side application, or a hybrid server-side/client-side application that is cooperatively executed by one or more of client applications 22, 24, 26, 28 and/or computing system 100.

In some implementations, one or more of client applications 22, 24, 26, 28 may be configured to effectuate some or all of the functionality of application 20 (and vice versa). Accordingly, in some implementations, application 20 may be a purely server-side application, a purely client-side application, or a hybrid server-side/client-side application that is cooperatively executed by one or more of client applications 22, 24, 26, 28 and/or application 20. As one or more of client applications 22, 24, 26, 28, computing system 100, and application 20, taken singly or in any combination, may effectuate some or all of the same functionality, any description of effectuating such functionality via one or more of client applications 22, 24, 26, 28, computing system 100, application 20, or combination thereof, and any described interaction(s) between one or more of client applications 22, 24, 26, 28, computing system 100, application 20, or combination thereof to effectuate such functionality, should be taken as an example only and not to limit the scope of the disclosure.

In some implementations, one or more of users 46, 48, 50, 52 may access computer 12 and computing system 100 (e.g., using one or more of user devices 38, 40, 42, 44) directly through network 14 or through secondary network 18. Further, computer 12 may be connected to network 14 through secondary network 18, as illustrated with phantom link line 54. Computing system 100 may include one or more user interfaces, such as browsers and textual or graphical user interfaces, through which users 46, 48, 50, 52 may access computing system 100.

In some implementations, the various user devices may be directly or indirectly coupled to network 14 (or network 18). For example, user device 38 is shown directly coupled to network 14 via a hardwired network connection. Further, user device 44 is shown directly coupled to network 18 via a hardwired network connection. User device 40 is shown wirelessly coupled to network 14 via wireless communication channel 56 established between user device 40 and wireless access point (i.e., WAP) 58, which is shown directly coupled to network 14. WAP 58 may be, for example, an IEEE 802.11a, 802.11b, 802.11g, Wi-Fi®, RFID, and/or Bluetooth™ (including Bluetooth™ Low Energy) device that is capable of establishing wireless communication channel 56 between user device 40 and WAP 58. User device 42 is shown wirelessly coupled to network 14 via wireless communication channel 60 established between user device 42 and cellular network/bridge 62, which is shown directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example, Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

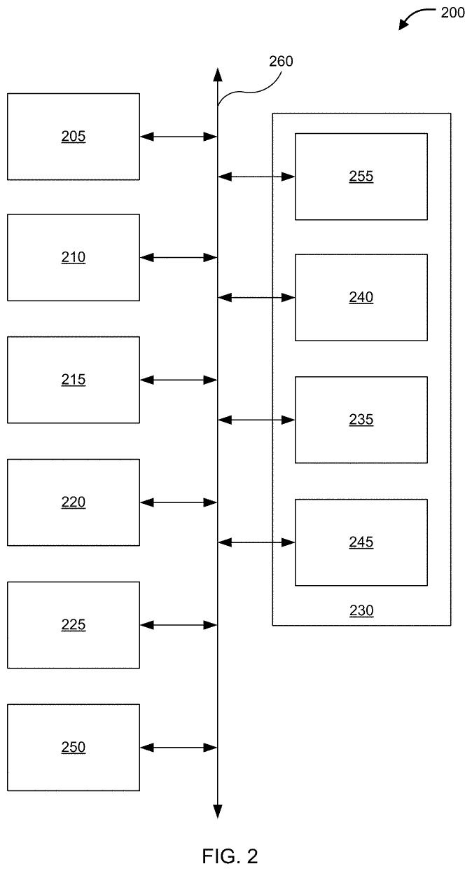

For the purposes of the present disclosure, the computing system 100 may include a controller. Herein, FIG. 2 is a block diagram of an example of a controller 200 capable of implementing embodiments according to the present disclosure. The controller 200 is implemented for issuing commands for reprogramming a trajectory of a robotic arm; and in particular for reprogramming the trajectory of the robotic arm based on a human interaction (as will be described later in more detail). Herein, the robotic arm may be implemented in an environment such as a warehouse environment, a manufacturing plant and the like; in which the robotic arms are typically implemented for moving load from one position to another position, and the like. In one embodiment, the application 20 for reprogramming a trajectory of a robotic arm based on a human interaction as described above may be executed as a part of the controller 200 as described herein. Thereby, for example in case of a warehouse, the computing system 100 may be a broader system such as the warehouse management system (WMS) as known in the art, in which the controller 200 may be executed for reprogramming a trajectory of a robotic arm based on a human interaction. Hereinafter, the terms “computing system 100” and “controller 200” have sometimes been broadly interchangeably used to represent means for reprogramming the trajectory of the robotic arm, without any limitations.

In the example of FIG. 2, the controller 200 includes a processing unit 205 for running software applications (such as, the application 20 of FIG. 1) and optionally an operating system. Memory 210 stores applications and data for use by the processing unit 205. Storage 215 provides non-volatile storage for applications and data and may include fixed disk drives, removable disk drives, flash memory devices, and CD-ROM, DVD-ROM or other optical storage devices. An optional user input device 220 includes devices that communicate user inputs from one or more users to the controller 200 and may include keyboards, mice, joysticks, touch screens, etc. A communication or network interface 225 is provided which allows the controller 200 to communicate with other computer systems via an electronic communications network, including wired and/or wireless communication and including an Intranet or the Internet. In one embodiment, the controller 200 receives instructions and user inputs from a remote computer through communication interface 225. Communication interface 225 can comprise a transmitter and receiver for communicating with remote devices. An optional display device 250 may be provided which can be any device capable of displaying visual information in response to a signal from the controller 200. The components of the controller 200, including the processing unit 205, the memory 210, the data storage 215, the user input devices 220, the communication interface 225, and the display device 250, may be coupled via one or more data buses 260.

In the embodiment of FIG. 2, a graphics system 230 may be coupled with the data bus 260 and the components of the controller 200. The graphics system 230 may include a physical graphics processing unit (GPU) 235 and graphics memory. The GPU 235 generates pixel data for output images from rendering commands. The physical GPU 235 can be configured as multiple virtual GPUs that may be used in parallel (concurrently) by a number of applications or processes executing in parallel. For example, mass scaling processes for rigid bodies or a variety of constraint solving processes may be run in parallel on the multiple virtual GPUs. Graphics memory may include a display memory 240 (e.g., a framebuffer) used for storing pixel data for each pixel of an output image. In another embodiment, the display memory 240 and/or additional memory 245 may be part of the memory 210 and may be shared with the processing unit 205. Alternatively, the display memory 240 and/or additional memory 245 can be one or more separate memories provided for the exclusive use of the graphics system 230. In another embodiment, graphics system 230 includes one or more additional physical GPUs 255, similar to the GPU 235. Each additional GPU 255 may be adapted to operate in parallel with the GPU 235. Each additional GPU 255 generates pixel data for output images from rendering commands. Each additional physical GPU 255 can be configured as multiple virtual GPUs that may be used in parallel (concurrently) by a number of applications or processes executing in parallel, e.g., processes that solve constraints. Each additional GPU 255 can operate in conjunction with the GPU 235, for example, to simultaneously generate pixel data for different portions of an output image, or to simultaneously generate pixel data for different output images. Each additional GPU 255 can be located on the same circuit board as the GPU 235, sharing a connection with the GPU 235 to the data bus 260, or each additional GPU 255 can be located on another circuit board separately coupled with the data bus 260. Each additional GPU 255 can also be integrated into the same module or chip package as the GPU 235. Each additional GPU 255 can have additional memory, similar to the display memory 240 and additional memory 245, or can share the memories 240 and 245 with the GPU 235. It is to be understood that the circuits and/or functionality of GPU as described herein could also be implemented in other types of processors, such as general-purpose or other special-purpose coprocessors, or within a CPU.

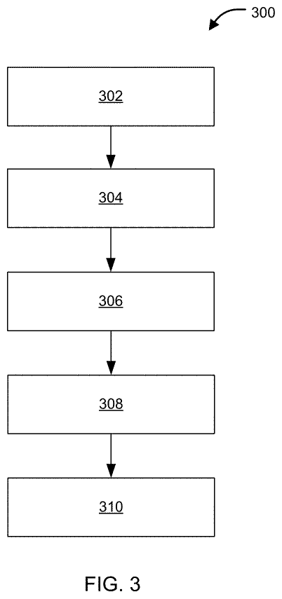

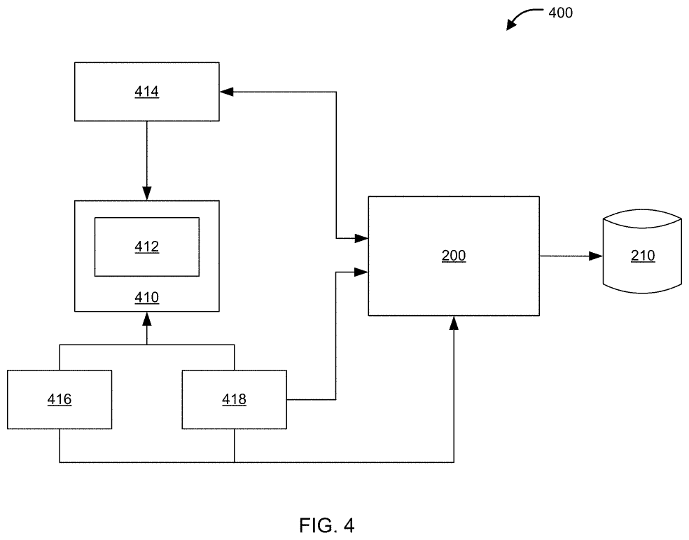

Referring to FIG. 3, illustrated is a flowchart listing steps involved in a method 300 for reprogramming a trajectory of a robotic arm based on a human interaction. The steps of the method 300 are implemented by a system, as illustrated in FIG. 4. In particular, FIG. 4 illustrates a schematic of a system 400 for reprogramming a trajectory of a robot/cobot based on a human interaction, in accordance with one or more embodiments of the present disclosure. It may be appreciated that the illustrated schematic of the system 400 is exemplary only and other possible arrangements for the system 400 may be contemplated by a person of ordinary skill in the art without departing from the spirit and the scope of the present disclosure.

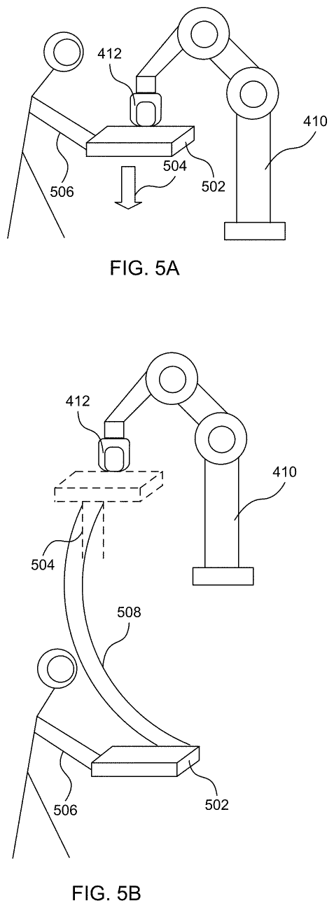

Herein, as illustrated in FIG. 4, the system 400 is specifically implemented for reprogramming a trajectory of a robotic arm (as represented by a block 410) based on the human interaction. Herein, the robotic arm 410 is a cobot as known in the art, and the two terms have been interchangeably used hereinafter without any limitations. Generally, the robotic arm 410 is a type of mechanical arm, usually programmable, with similar functions to a human arm; the arm may be the sum total of the mechanism or may be part of a more complex robot. The links of the robotic arm 410 are connected by joints allowing either rotational motion or translational displacement, such that the robotic arm 410 acts as a manipulator for compatible objects/load. Typically, the robotic arm 410 includes an end-effector (as represented by a block 412). In the robotic arm 410, the end-effector 412 is the device at the end of the robotic arm 410, designed to interact with the environment. The exact configuration of the end-effector 412 depends on the application of the robotic arm 410. In general, the end-effector 412 is adapted to support a load thereon (as shown and discussed later with reference to FIGS. 5A-5B).

In the exemplary configuration of the present disclosure, the robotic arm 410 is adapted to be movable by a motor arrangement (as represented by a block 414). Generally, the motor arrangement 414 may include multiple motors (not shown or labelled), like servo motors, with one of such motors being associated with each joint in the robotic arm 410. Herein, the term “motor arrangement 414” has been used to collectively refer to combined configuration of such motors therein; however, it may be understood that when reference is made with respect to a particular function of the motor arrangement 414, it may be construed to refer to one, multiple or all of such motors as appropriate with respect to that function. Further, sometimes the term “motor” has been simply used for the “motor arrangement” without any limitations. As shown in the schematic of FIG. 4, the motor arrangement 414 is in signal communication with the controller 200 (as described in reference to FIG. 2). Each of the said motors, in the motor arrangement 414, may be configured to vary its position, velocity and torque as required, which can be controlled by the controller 200, for performing the operations defined for the robotic arm 410.

Also, as shown in FIG. 4, the system 400 includes a first sensing arrangement 416. The first sensing arrangement 416 is associated with the robotic arm 410. In particular, the first sensing arrangement 416 may be associated with the end-effector 412 of the robotic arm 410. The first sensing arrangement 416 is configured to detect the human interaction related to the end-effector 412. That is, if there is any human interaction that may affect the behaviour of the end-effector 412, the first sensing arrangement 416 is configured to detect such human interaction. Generally, for the purposes of the present disclosure, the human interaction is in the form of some force being exerted on the end-effector 412, to cause the end-effector 412 to deviate from a programmed trajectory thereof. The first sensing arrangement 416 may further be disposed in signal communication with the controller 200 to communicate information related to the detection of the human interaction thereto.

Further, as shown in FIG. 4, the system 400 includes a second sensing arrangement 418. The second sensing arrangement 418 is associated with the robotic arm 410. In particular, the second sensing arrangement 418 may be associated with the end-effector 412 of the robotic arm 410. The second sensing arrangement 418 is configured to determine an instantaneous positional coordinate of the end-effector 412. For this purpose, the second sensing arrangement 418 may be in the form of a position sensor which may determine relative position of the end-effector 412 at each instant, and may thus be able to determine a trajectory being followed by the end-effector 412. The second sensing arrangement 418 may further be disposed in signal communication with the controller 200 to communicate information related to the determined instantaneous positional coordinates of the end-effector 412 thereto.

FIGS. 5A-5B illustrate depictions representing the human interaction on the robotic arm 410, in accordance with one or more embodiments of the present disclosure. As illustrated in FIG. 5A, the end-effector 412 may be carrying a load 502 threat. The robotic arm 410 is operated to cause movement of the end-effector 412, and thereby the load 502, thereof along a first trajectory 504 predefined therefor. As shown, the load 502 (and consequently, the end-effector 412) is being affected by a human interaction (as represented by reference numeral 506). Herein, as discussed, the human interaction 506 may be in the form of a force provided by the human operator, and the said two terms “human interaction” and “force” have been sometimes interchangeably used hereinafter. Further, as illustrated in FIG. 5B, the human interaction 506 may cause the load 502 (along with the end-effector 412) to move in response thereto, deviating from the first trajectory 504 (as represented by dashed lines). As shown, the load 502 (along with the end-effector 412) moves along a second trajectory (as represented by solid lines 508) different from the first trajectory 504 in response to the human interaction 506.

In the example illustrations of FIGS. 5A-5B, as shown, the robotic arm 410 holds the load 502. It may not be necessary that the human operator (or even the robotic arm 410) may know the exact properties of the attached load 502. The human operator pushes the robotic arm 410 in a desired manner and the robotic arm 410 follows suit. It may be understood that the effort by the human operator is invariant to the load 502 attached on the robotic arm 410, as the robotic arm 410 handles the load 502. For instance, in the present configuration, the effort by the human operator to push aside a 1 kg load or a 100 kg load may generally be similar. Further, as shown specifically in FIG. 5B, the human operator pushes the load 502 (and thereby the end-effector 412 of the robotic arm 410) to a new trajectory (i.e., the second trajectory 508) to a desired location, while the robotic arm 410 may be programmed to have the end-effector 412 move along the first trajectory 504.

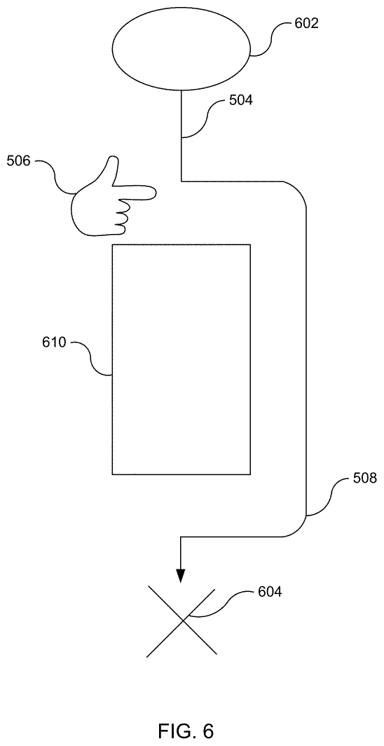

FIG. 6 illustrates a representation of reprogramming of the trajectory of the end-effector (such as the end-effector 412, not shown in FIG. 6) of the robotic arm (such as the robotic arm 410, not shown in FIG. 6) based on the human interaction 506, in accordance with one or more embodiments of the present disclosure. As shown in FIG. 6, in combination with FIGS. 4 and 5A-5B) the end-effector 412 of the robotic arm 410 may start from a first position 602 (initial position 602), with the end-effector 412 being pre-programmed to follow the first trajectory 504 to be moved to a second position 604 (goal position 604). As shown in the illustrated example, the end-effector 412 may have (encounter) an obstacle 610 located in the path defined by the first trajectory 504. In such case, the human operator may deviate the end-effector 412 of the robotic arm 410 from the defined path (i.e., the first trajectory 504) by providing the human interaction 506 to cause the end-effector 412 to follow the second trajectory 508 while still moving from (or between) the first position 602 and the second position 604.

It may be appreciated that in the system 400 of the present disclosure, the motor arrangement 414 may provide the movement of the end-effector 412 of the robotic arm 410; the first sensing arrangement 416 may be configured to detect the human interaction 506 onto the load 502 (and thereby the end-effector 412 of the robotic arm 410), and the second sensing arrangement 418 may be configured to determine the first trajectory 504 as well as the second trajectory 508 of the end-effector 412 of the robotic arm 410. The controller 200 is in signal communication with the motor arrangement 414, the first sensing arrangement 416, and the second sensing arrangement 418. The controller 200 is further in signal communication with the memory 210 to store information related to the programmed path for the end-effector 412 of the robotic arm 410 and/or the reprogrammed path as determined based on the human interaction 506.

Referring back to the flowchart of FIG. 3, at step 302, the method 300 includes configuring the motor arrangement 414 to operate the robotic arm 410 to cause movement of the end-effector 412 thereof along the first trajectory 504 predefined therefor, in between the first position 602 and the second position 604. Herein, the controller 200 is configured to configure the motor arrangement 414 to operate the robotic arm 410 to cause movement of the end-effector 412 thereof along the first trajectory 504 predefined therefor. In particular, the end-effector 412 of the robotic arm 410 moves in a direction based on the torque feedback at the joints of the motors in the motor arrangement 414. Such movement, as provided by the motor arrangement 414, may be pre-programmed as stored in the memory 210, and the controller 200 may convert the waypoints as stored in the memory 210 to operational instructions for the motors in the motor arrangement 414 and communicate such operational instructions to the motor arrangement 414 for achieving the said pre-programmed movement.

In some embodiments, the method 300 further includes configuring the motor arrangement 414 to generate an opposing force to the human interaction 506, to resist movement of the end-effector 412 with corresponding one or more instantaneous positional coordinates being beyond a predefined bounded operational coordinate space. Herein, the controller 200 is configured to configure the motor arrangement 414 to generate an opposing force to the human interaction 506, to resist movement of the end-effector 412 with corresponding one or more instantaneous positional coordinates being beyond a predefined bounded operational coordinate space. As may be understood by a person skilled in the art that the end-effector 412 of the robotic arm 410 may have the bounded operational coordinate space (also known as working envelope) predefined therefor. Such bounded operational coordinate space may define a volume beyond which the end-effector 412 of the robotic arm 410 may not be allowed to operate; for instance, because of obstacles, other working environments, etc. Now, if the human interaction 506 as provided by the human operator may be causing the end-effector 412 to be moved beyond the corresponding bounded operational coordinate space, the controller 200 may resist such movement by configuring the motor arrangement 414 to provide opposing force or the like, to have the second trajectory 508 defined within limits of the said bounded operational coordinate space.

At step 304, the method 300 includes detecting the human interaction 506 related to the end-effector 412, while the end-effector 412 is moving along the first trajectory 504. Herein, the controller 200 is configured to detect, via the first sensing arrangement 416, the human interaction 506 related to the end-effector 412, while the end-effector 412 is moving along the first trajectory 504. As discussed, the end-effector 412 of the robotic arm 410 may start from the first position 602, with the end-effector 412 being pre-programmed to follow the first trajectory 504 to be moved to the second position 604. In some cases, the human operator may deviate the end-effector 412 of the robotic arm 410 from the first trajectory 504 by providing the human interaction 506 to cause the end-effector 412 to follow the second trajectory 508 while still moving from (or between) the first position 602 and the second position 604. Herein, the first sensing arrangement 416 may be configured to detect the human interaction 506 onto the load 502 (and thereby the end-effector 412 of the robotic arm 410).

In an embodiment, the method 300 further comprises detecting the human interaction 506 related to the load 502 supported by the end-effector 412 of the robotic arm 410. Herein, the controller 200 is further configured to detect, via the first sensing arrangement 416, the human interaction 506 related to the load 502 supported by the end-effector 412 of the robotic arm 410. As may be understood and discussed in reference to FIGS. 5A-5B, since the load 502 is supported (attached) to the end-effector 412 of the robotic arm 410, any human interaction 506 related to the load 502 may be translated to the end-effector 412, and thus be detected by the first sensing arrangement 416.

At step 306, the method 300 includes determining instantaneous positional coordinates to which the end-effector 412 is moved in response to the human interaction 506, deviating from the first trajectory 504. Herein, the controller 200 is configured to determine, via the second sensing arrangement 418, instantaneous positional coordinates to which the end-effector 412 is moved in response to the human interaction 506, deviating from the first trajectory 504. That is, the second sensing arrangement 418 may be configured to determine the second trajectory 508 of the end-effector 412 of the robotic arm 410.

At step 308, the method 300 includes recording the determined instantaneous positional coordinates. Herein, the controller 200 is configured to record, in the memory 210, the determined instantaneous positional coordinates. The instantaneous positional coordinates may be recorded in the memory 210 as a set of local coordinates in a workspace for the end-effector 412 of the robotic arm 410. Such step 308 of recording the instantaneous positional coordinates in the memory 210 may be contemplated by a person skilled in the art of robotics and thus has not been explained in detail herein for the brevity of the present disclosure.

In an embodiment, the instantaneous positional coordinates are determined in response to each of at least two human interactions 506 causing the end-effector 412 to deviate from the first trajectory 504, with the corresponding determined instantaneous positional coordinates resultant of each of the at least two human interactions 506 being within a predefined distance from each other. Herein, the controller 200 is configured to determine, via the second sensing arrangement 418, the instantaneous positional coordinates in response to each of at least two human interactions 506 causing the end-effector 412 to deviate from the first trajectory 504, with the corresponding determined instantaneous positional coordinates resultant of each of the at least two human interactions 506 being within a predefined distance from each other. Further, in an embodiment, the determined instantaneous positional coordinates are recorded in case of detection of at least two human interactions 506 causing the end-effector 412 to deviate from the first trajectory 504 predefined therefor. Herein, the controller 200 is configured to record, in the memory 210, the determined instantaneous positional coordinates via the second sensing arrangement 418, in case of detection of the human interaction 506, via the first sensing arrangement 416, of at least two human interactions 506 causing the end-effector 412 to deviate from the first trajectory 504 predefined therefor. As would be contemplated for further discussion in the subsequent paragraphs, the determined instantaneous positional coordinates are utilized to define new trajectory as per the human interaction 506, since that may be understood to be the intention of the human operator. However, as may be appreciated, for that purpose the human operator may need to provide similar inputs (i.e., the human interactions 506) at least two times so that it may be made sure that it may be the intent of the human operator to actually change the current trajectory and define the new trajectory for the end-effector 412. This is the reason that at least two human interactions 506 are considered, i.e., first detected by the first sensing arrangement 416, before the instantaneous positional coordinates are determined by the second sensing arrangement 418 and/or be stored in the memory 210.

At step 310, the method 300 includes configuring the motor arrangement 414 to operate the robotic arm 410 with movement of the end-effector 412 thereof along the second trajectory 508 based on the recorded instantaneous positional coordinates, in between the first position 602 and the second position 604. Herein, the controller 200 is configured to configure the motor arrangement 414 to operate the robotic arm 410 with movement of the end-effector 412 thereof along the second trajectory 508 based on the recorded instantaneous positional coordinates, in between the first position 602 and the second position 604. That is, once the human interaction(s) 506 is detected, the instantaneous positional coordinates (i.e., the change in trajectory) has been determined and recorded in the memory 210, and further the intention of the human operator for causing the change in the trajectory has been confirmed (as discussed above), the end-effector 412 of the robotic arm 410 is re-programmed to follow the changed trajectory (i.e., the second trajectory 508) thereafter.

Thereby, according to discussed aspects, the method 300 and the system 400 of the present disclosure leverage the human interaction 506 on the robotic arm 410 in order to update the trajectory of the robotic arm 410. Herein, the predefined planning algorithm to the robotic arm 410 may be dynamically changed due to the human interaction 506. The update to the robotic arm 410 based on the human interaction 506 may be modified by the repeatability of the update by the human on the robotic arm 410. The present method 300 and the system 400 thus provides ability for the human to co-operate with the robotic arm 410 and also provide human aware trajectory updation for the robotic arm 410 without the need of manual reprogramming.

Herein, the first stage involves intent estimation, where the end-effector 412 of the cobot 410 may be moving in a direction based on the torque feedback at the joints of the motors 414. Initially, the force 506 applied by the human operator on the cobot 410 is estimated based on the inertial parameters and configuration of the cobot 410. Then, the motion of the end-effector 412 of the cobot 410 is predicted based on the applied force by the human operator. The motors 414 of the cobot 410 then react in such a way that the force 506 applied by the human operator on the end-effector 412 is reduced. Herein, the motors 414 coordinate in such a way that the end-effector 412 of the cobot 410 achieves the desired goal position 604. The instantaneous motor velocity commands ensure that the end-effector 412 is always directed towards the goal position 604. Based on the human interaction 506 with the end-effector 412 of the cobot 410, the motion commands to the motor 414 are then modified based on the additional torque at the motors 414. When, the human operator interacts with the moving cobot 410; the actual torque values and the predicted torque values differ. The predicted torque is based on the current configuration and the subsequent motion of the cobot 410. The exact intention of the human operator is identified and the cobot 410 is directed in the direction of the intended motion by the human operator.

Embodiments of the present disclosure combine the motion of the end-effector 412 of the cobot 410 based on the described goal position and the human interaction 506 to the end-effector 412. The behaviour of the end-effector 412 of the cobot 410 is generally based on moving towards the goal and moving based on the intent of the human operator, which can be controlled by incorporating appropriate weights to each of the two cases. For instance, for a particular use case, the cobot 410 might need to aggressively target the goal position 604 while the component of the human interaction 506 with the cobot 410 might need to be limited. In another exemplary scenario, the cobot 410 might need to be very passive in achieving the goal position 604 and the human operator should be easily able to push the end-effector 412 towards a secondary position. However, in either of the two exemplary scenarios, once the force implied at the end-effector 412 by the human goes to zero, the end-effector 412 aggressively directs itself towards the goal position 604.

Now, while the human operator dynamically interacts with the cobot 410 and changes its trajectory, the new trajectory points are recorded. A neural network/differential equation is then trained on the deviation of the original trajectory of the end-effector 412 of the cobot 410 and the new trajectory based on the human interaction 506 (be it a passive or an aggressive behaviour). Traditional imitation learning or inverse reinforcement learning methods are deployed for the same. Then, the new trajectory points are used to modify the underlying planned trajectory. The contribution of the new trajectory vis-a-vis the original trajectory can be tuned. For instance, a single modified trajectory by the human on the end-effector 412 of the cobot 410 may be used to synthesize a new planning methodology. In another embodiment, multiple trajectories shall affect the underlying planner. The contribution of new trajectories to modify the underlying planning methodology may be modified by a designated user of the cobot 410.

In one or more examples, certain regions within the environment may be characterized as No-Go zones or Difficult-To-Go zones. When the cobot 410 is moving to the desired goal or when the human is pushing the end-effector 412 of the cobot 410; the exact coordinates of the end-effector 412 can be estimated from encoders of the motor 414. The No-Go zones are predefined in terms of the Euclidean coordinates. Once the cobot 410 reaches the boundary of a No-Go zone, some directions are characterized as not feasible. Once one or many directions are characterized as unfeasible, the algorithm is coded to believe a large hypothetical force is applied at the end-effector 412 which the human operator may not be able to overcome. Hence, the human operator would not be able to move the cobot 410 in the restricted direction. The Difficult-To-Go zones are characterized by a smaller force limit where the human operator may be able to push the cobot 410 by applying a considerably larger but achievable force. All the limits, directions and the regions can be modified by the designated user of the cobot 410.

These stages are interrelated to deploy a successful methodology which adapts to the trajectory as demanded by the human operator of the cobot 410. The present methodology related to implementing of the human interaction 506 with the cobot 410 may allow the human operator to push the end-effector 412 of the cobot 410 while the cobot 410 is under motion, even when the mass/inertial properties of the cobot 410 and the load 502 attached to the end-effector 412 is unknown. The present method 300 and the system 400 allow for the human intervention which results in a dynamic change in trajectory of the cobot 410, as compared to the traditionally planned (pre-programmed) trajectory. The change in the trajectory is then used to update base planner for the cobot 410, thereby mimicking the behaviour in absence of human as well. Further, the present method 300 and the system 400 formulate fake regimes for the cobot 410 where the human cannot push the cobot 410 to ensure work safety.

The present method 300 and the system 400 implement AI (Artificial Intelligence) based module to understand the change in the trajectory demanded by the human operator and to dynamically modify the underlying path planning strategy to inculcate the desired changes as demanded by the human interaction 506. The present method 300 and the system 400 allow for dynamic change in the trajectory based on the human interaction 506 when the load 502 attached to the end-effector 412 of the cobot 410 is unknown. The cobot 410 moves to accommodate the human interaction 506 while trying to reach the goal position 604. Thus, the behaviour of the cobot 410 may be modified to accommodate the contribution of the motion forced by the human operator.

The present method 300 and the system 400 provide for implementation of the cobot 410 in assembly of electronics components where the human operator might need to hand-hold the cobot 410 for precise applications; implementation of the cobot 410 in heavy duty assembly line where the human operator might need to intervene to change the trajectory of the cobot 410 carrying a heavy mass; implementation of the cobot 410 in therapeutics where the optimal therapy trained by the doctor might be different for each patient and the doctor might need to re-train the same each time; implementation of the cobot 410 to assist the human operator in carrying heavy loads; implementation of the cobot 410 in semi-autonomous surgery where the doctor need to dynamically change the trajectory of the cobot 410 while performing a surgical operation; and implementation of the cobot 410 in semi-autonomous tele-operative Imaging where the cobot 410 performing a tele-operative imaging can be corrected by a doctor agent and unwarranted regimes can be prevented limiting the doctor to move the cobot 410 in unsafe regimes; and the like.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

1. A method for reprogramming a trajectory of a robotic arm based on a human interaction, the robotic arm comprising an end-effector adapted to support a load and adapted to be movable by a motor arrangement, the method comprising:
configuring the motor arrangement to operate the robotic arm to cause movement of the end-effector thereof along a first trajectory predefined therefor, in between a first position and a second position;
detecting the human interaction related to the end-effector, while the end-effector is moving along the first trajectory;
determining instantaneous positional coordinates to which the end-effector is moved in response to the human interaction, deviating from the first trajectory;
recording the determined instantaneous positional coordinates; and
configuring the motor arrangement to operate the robotic arm with movement of the end-effector thereof along a second trajectory based on the recorded instantaneous positional coordinates, in between the first position and the second position.

2. The method as claimed in claim 1 further comprising configuring the motor arrangement to generate an opposing force to the human interaction, to resist movement of the end-effector with corresponding one or more instantaneous positional coordinates being beyond a predefined bounded operational coordinate space.

3. The method as claimed in claim 1, wherein the instantaneous positional coordinates are determined in response to each of at least two human interactions causing the end-effector to deviate from the first trajectory, with the corresponding determined instantaneous positional coordinates resultant of each of the at least two human interactions being within a predefined distance from each other.

4. The method as claimed in claim 1, wherein the determined instantaneous positional coordinates are recorded in case of detection of at least two human interactions causing the end-effector to deviate from the first trajectory predefined therefor.

5. The method as claimed in claim 1 further comprising detecting the human interaction related to the load supported by the end-effector of the robotic arm.

6. A system for reprogramming a trajectory of a robotic arm based on a human interaction, the robotic arm comprising an end-effector adapted to support a load and adapted to be movable by a motor arrangement, the system comprising:
a first sensing arrangement configured to detect the human interaction related to the end-effector;
a second sensing arrangement configured to determine an instantaneous positional coordinate of the end-effector;
a memory;
a controller in signal communication with the motor arrangement, the first sensing arrangement, the second sensing arrangement and the memory, the controller being configured to:
configure the motor arrangement to operate the robotic arm to cause movement of the end-effector thereof along a first trajectory predefined therefor, in between a first position and a second position;
detect, via the first sensing arrangement, the human interaction related to the end-effector, while the end-effector is moving along the first trajectory;
determine, via the second sensing arrangement, instantaneous positional coordinates to which the end-effector is moved in response to the human interaction, deviating from the first trajectory;
record, in the memory, the determined instantaneous positional coordinates; and
configure the motor arrangement to operate the robotic arm with movement of the end-effector thereof along a second trajectory based on the recorded instantaneous positional coordinates, in between the first position and the second position.

7. The system as claimed in claim 6, wherein the controller is further configured to configure the motor arrangement to generate an opposing force to the human interaction, to resist movement of the end-effector with corresponding one or more instantaneous positional coordinates being beyond a predefined bounded operational coordinate space.

8. The system as claimed in claim 6, wherein the controller is configured to determine, via the second sensing arrangement, the instantaneous positional coordinates in response to each of at least two human interactions causing the end-effector to deviate from the first trajectory, with the corresponding determined instantaneous positional coordinates resultant of each of the at least two human interactions being within a predefined distance from each other.

9. The system as claimed in claim 6, wherein the controller is configured to record, in the memory, the determined instantaneous positional coordinates in case of detection, via the first sensing arrangement, of at least two human interactions causing the end-effector to deviate from the first trajectory predefined therefor.

10. The system as claimed in claim 6, wherein the controller is further configured to detect, via the first sensing arrangement, the human interaction related to the load supported by the end-effector of the robotic arm.
